(19) United States
(12) Patent Application Publication
(10) Pub. No.: US 2024/0372640 A1
(43) Pub. Date: Nov. 7, 2024

(54) PROCESSING DEVICE AND METHOD FOR PERFORMING TIME STAMPING

(71) Applicant: Renesas Electronics Corporation, Tokyo (JP)

(72) Inventors: Christian MARDMÖLLER, Düsseldorf (DE); Mohamed SOUBHI, Düsseldorf (DE); Stefan GELDREICH, Düsseldorf (DE)

(21) Appl. No.: 18/635,469

(22) Filed: Apr. 15, 2024

(30) Foreign Application Priority Data
May 2, 2023 (DE) 102023204032.8

(51) Int. Cl. H04J 3/06; H04L 1/00; H04L 67/12

(52) U.S. Cl. CPC H04J 3/0661; H04L 1/0061; H04L 67/12

(57) ABSTRACT

The present document relates to a processing device and a method for performing time stamping of data at a high level of integrity such as ASIL (Automotive Safety Integrity Level) D. The processing device processes a data frame comprising data. Furthermore, upon reception of a trigger which is indicative of the processing of the data frame, the processing device captures a time stamp using a primary timer. Next, the processing device generates validation data based on the data frame and the time stamp. In addition, the processing device stores the validation data in conjunction with the data frame and the time stamp in a memory module.

### CROSS-REFERENCE TO RELATED APPLICATIONS

The disclosure of German Patent Application No. 102023204032.8 filed on May 2, 2023, including the specification, drawings and abstract is incorporated herein by reference in its entirety.

### BACKGROUND

The present document relates to a device and a method for performing time stamping of data at a high level of integrity such as ASIL (Automotive Safety Integrity Level) D.

A vehicle comprises different environmental sensors (such as a camera, a radar sensor, a lidar sensor, etc.) which are configured to capture sensor data regarding the environment of the vehicle. The sensor data of the different sensors may be fused to determine a model of the environment of the vehicle. This model may be used to provide an advanced driver assistance system (ADAS) and/or autonomous driving.

The different sensors typically provide sensor data at different time instants. The quality, in particular the reliability and/or the integrity, of data fusion typically depends on the reliability and/or the integrity of time synchronization of the sensor data of the different sensors. The quality of data fusion typically depends on the reliability and/or the integrity of the time stamps which are provided along with the data frames of the different sensors.

The present document is directed at the technical problem of performing time stamping of data, such as sensor data, at a high level of reliability and/or integrity. The present document is directed at distributing time within a communication network, e.g., a communication network of a vehicle, in a reliable manner, such that the different electronic control units of the vehicle have the same temporal basis. It should be noted that the methods and devices, which are described in the present document, are applicable to safety critical applications in general (such as aerospace applications and/or medical applications, etc.).

### SUMMARY

According to an aspect, a processing device configured to process (e.g., in the context of receiving or transmitting) a data frame comprising data, such as sensor data, is described. The processing device is further configured, upon reception of a trigger which is indicative of the processing of the data frame, to capture a time stamp using a primary timer. In addition, the processing device is configured to generate validation data based on the data frame and the time stamp, and to store the validation data in conjunction with the data frame and the time stamp in a memory module.

According to a further aspect, a method for time stamping data with one or more data frames, at a communication interface is described. The method comprises processing (e.g., in the context of receiving or transmitting) a data frame comprising data, and, upon reception of a trigger which is indicative of the processing of the data frame, capturing a time stamp using a primary timer. Furthermore, the method comprises generating validation data based on the data frame and the time stamp, and storing the validation data in conjunction with the data frame and the time stamp in a memory module.

According to a further aspect, a software program is described. The software program may be adapted for execution on a processor and for performing the method steps outlined in the present document when carried out on the processor.

According to another aspect, a storage medium is described. The storage medium may comprise a software program adapted for execution on a processor and for performing the method steps outlined in the present document when carried out on the processor.

It should be noted that the methods and systems including its embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. The features of the claims may be combined with one another in an arbitrary manner.

### BRIEF DESCRIPTION OF THE DRAWINGS

FIG. 1A shows an example of a communication system with processing devices comprising a communication interface with a transmission unit and a reception unit.

FIG. 1B shows an example of a reception unit.

FIG. 1C shows an example of a transmission unit.

FIG. 1D shows an example of a data package comprising a data frame.

FIG. 2A shows an example of a reception unit with a generator for verification data.

FIG. 2B shows an example of a transmission unit with a generator for verification data.

FIG. 3 shows a flow chart of an example of a method for time stamping data.

### DETAILED DESCRIPTION

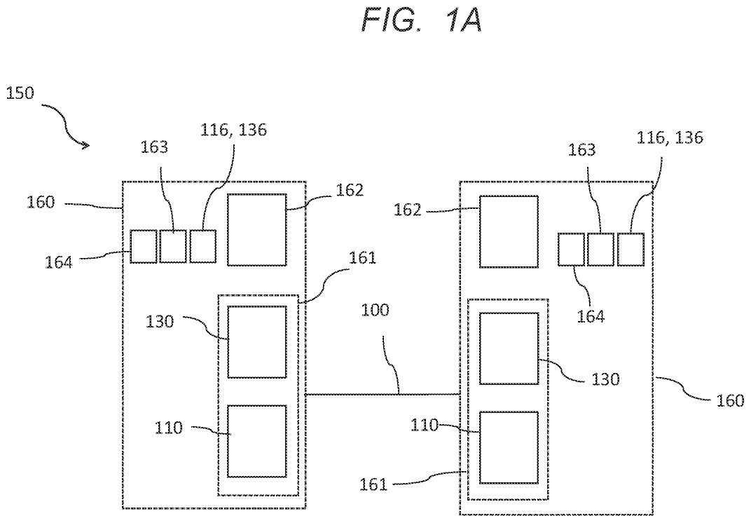

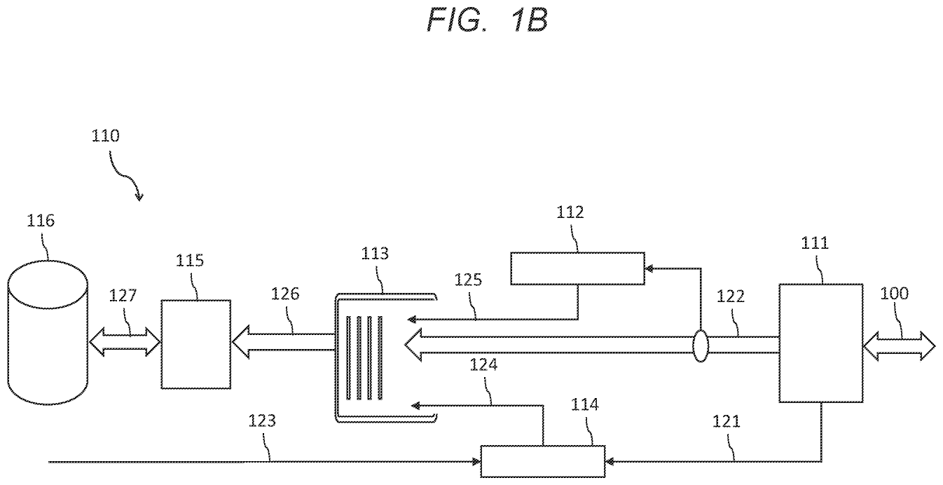

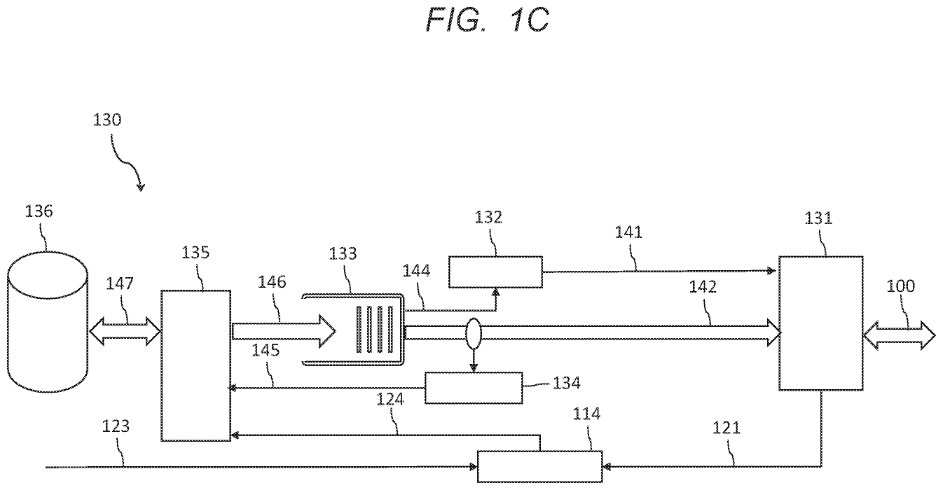

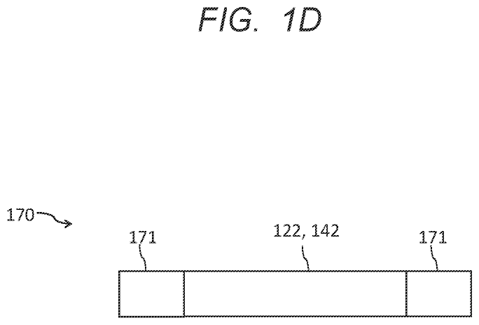

As indicated above, the present document is directed at increasing the reliability and/or the integrity level of time stamping data. In this context, FIG. 1A shows an example of a communication system 150 comprising processing devices 160. A processing device 160 may comprise a communication interface 161 with a transmission unit 130 for transmitting data over a communication path 100, such as an Ethernet link, and a reception unit 110 configured to receive data via the communication path 100. The communication interface 161 in the processing device 160 may be integrated within a microcontroller unit (MCU) or within a system on chip (SoC). The communication interface 161 may comprise one or more (hardware-based) timers, notably a primary timer 163 and/or a secondary timer 164, as described below. The clock which is used for the one or more timers 163, 164 may be the same. Alternatively, different timers 163, 164 may use different clocks. In addition, the processing device 160 may comprise a memory module 116, 136, wherein the memory module 116, 136 may be part of the communication interface 161. An electronic control unit (ECU) of a vehicle may comprise one or more processing devices 160.

A processing device 160 may further comprise a processor unit 162, e.g., with a central processing unit (CPU). The processor unit 162 may be configured to execute software for performing one or more of the functions that are described in the present document.

It should be noted that the processing devices 160 on two sides of a communication path 100 may be implemented in different manners. The aspects which are described in the present document may be implemented in only one of the processing devices 160 or in both processing devices 160.

FIG. 1B shows a block diagram of an example of a reception unit 110. The reception unit 110 comprises (among other components and/or logic, such as a shift register and/or a control and status logic) a frame state machine (FSM) 111 which is configured to identify the individual data frames 122 of a data stream which is received via the communication path 100. The FSM 111 is configured to pass the individual data frames 122 to a storage module 113 (notably a FIFO (First In First Out) module). Furthermore, the FSM 111 is configured to pass the start frame delimiter (SFD) 121 of the preamble of the individual frames 122 to a time stamp capture module 114. The SFD 121 of a data frame 122 may be considered to be a trigger which is indicative of the fact that the data frame 122 has been received at the reception unit 110. Hence, the FSM 111 may be considered to be a trigger module configured to generate a trigger 121 which is indicative of the reception of a data frame 122.

Hence, the reception unit 110 may comprise a trigger module 111 which is configured to identify a pre-defined trigger 121, i.e., a point or data entity, within a data frame for triggering time stamping. In the case of Ethernet, the trigger 121 may be the SFD. In the case of a different protocol, such as CAN (Controller Area Network) and/or PCIe (Peripheral Component Interconnect Express) and/or another protocol, the trigger 121 may be a different data entity.

The time stamp capture module 114 is configured to capture a time stamp 124 for the data frame 122 at the time instant that the SFD 121 is received by the time stamp capture module 114. The time stamp 124 may be determined using time values of a primary time 123 provided by the primary timer 163, wherein the primary timer 163 may make use of a clock which has been synchronized using e.g. gPTP (generalized Precision Time Protocol). The time stamp 124 is provided to the storage module 113 in conjunction with the corresponding data frame 122.

The reception unit 110 may further comprise a classification module 112 which is configured to assign a DMA (Direct Memory Access) channel number 125 to the metadata of the individual data frame 122 (based on data comprised within the data frame 122). The DMA channel number 125 of the data frame 122 may be stored in conjunction with the corresponding data frame 122 within the storage module 113. The data frame 122 may comprise metadata regarding the actual payload of the frame which has been received via the communication path 100.

Hence, an individual data frame 122 comprising data (such as sensor data from a sensor) may be stored in conjunction with a DMA channel number 125 (as part of the metadata of the frame 122) and in conjunction with a time stamp 124 (which is indicative of the time instant that the frame 122 has been received at the reception unit 110). This extended frame data 126 may be stored within a memory module 116 (e.g., a random access memory (RAM)) using a DMA controller 115 via an interface bus (e.g., AXI) 127. The storage location within the memory module 116 may be dependent on the DMA channel number 125. The extended frame data 126 may comprise a DMA channel number 125, the data frame 122, the time stamp 124 and/or the validation data 211.

It may occur that in case of an erroneous operation of the reception unit 110, the time stamp 124 of a data frame 122 is altered and/or the data frame 122 is associated with the wrong time stamp 124.

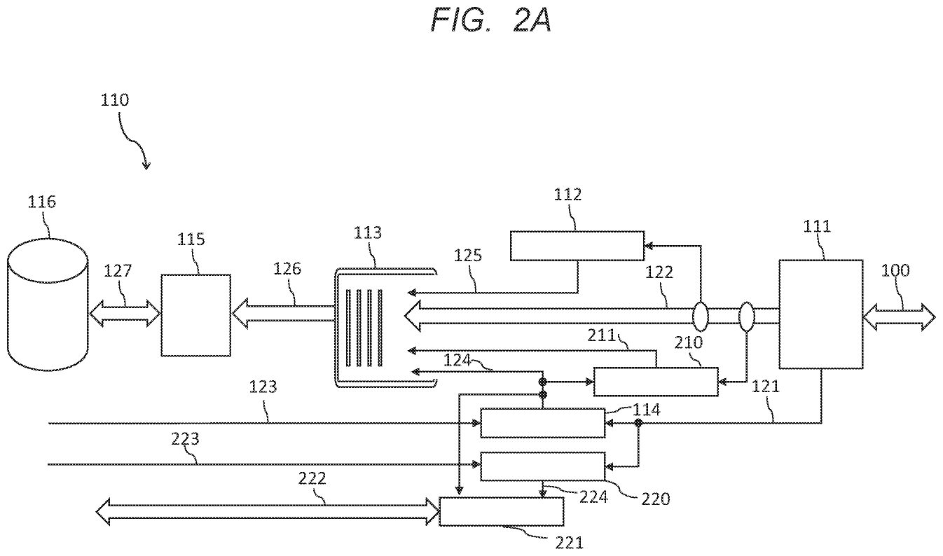

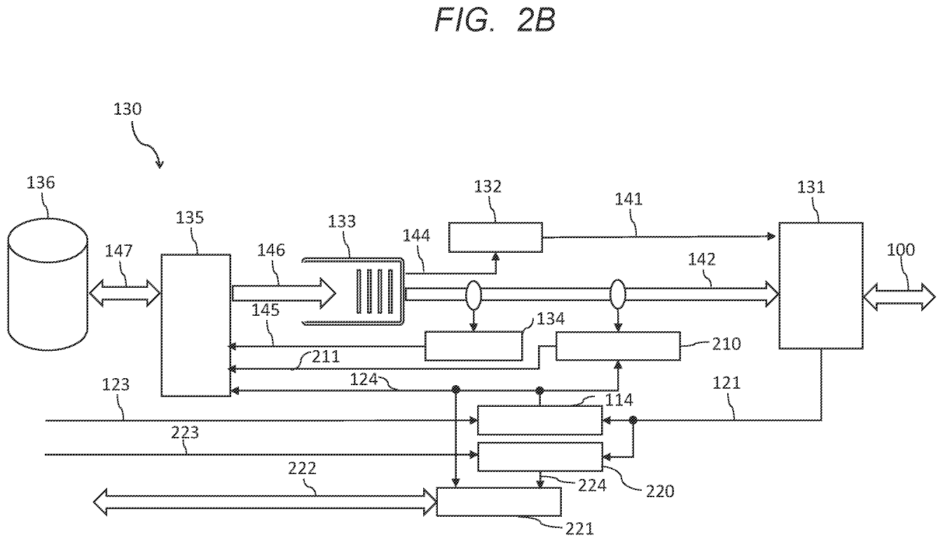

FIG. 2A shows an example of a reception unit 110 which comprises a generator 210 for generating validation data 211 based on the data of the data frame 122 and based on the time stamp 124. The validation data 211 may comprise or may be an error-detecting code, such as CRC (cyclic redundancy check), which is calculated over the data of the frame 122 and the time stamp 124 using a pre-defined data generation method. The validation data 211 may be stored in conjunction with the frame 122, to provide extended frame data 126 which also comprises the validation data 211.

The validation data 211 may be used to detect an erroneous situation where the time stamp 124 of a data frame 122 has been altered and/or is incorrect. For this purpose, the validation data 211 may be compared with the time stamp 124 that is stored (within the memory module 116) in conjunction with the data frame 122. The verification data may be generated based on the data of the data frame 122 and based on the time stamp 124 that is stored in conjunction with the data frame 122 (using the above-mentioned data generation method). The verification data may comprise or may be an error-detecting code (for example, CRC). If the validation data 211 differs from the verification data, the frame 122 may be discarded and a hardware fault may be reported. Otherwise, frame and time stamp processing may be continued. The comparison of the validation data 211 and the verification data may be performed within software on a CPU 162 or using a dedicated hardware.

The frame 122, for which the time stamp 124 is captured and for which the validation data 211 is generated, may be a frame for clock synchronization. The data of the frame 122 may be indicative of a clock value. The clock value comprised within the frame 122 may be used in conjunction with the time stamp 124 (of the local primary time 123 at the reception unit 110, which is provided by the primary timer 163), to provide a precise clock and/or synchronization (e.g., using gPTP). The primary timer 163 may having been synchronized using the gPTP protocol.

Another cause for performing erroneous time stamping may be an error of the time stamp capture module 114 and/or of the trigger module 111. By way of example, it may occur that the time stamp capture module 114 does not update the time stamp 124 and remains stuck with a constant value of the time stamp. For this purpose, a redundant capture module 220 may be provided which is configured to capture a redundant time stamp 224 at the time instant of an SFD 121, using a redundant and/or secondary timer 164, which provides a secondary time 223.

The redundant time stamp 224 may be compared with the primary time stamp 124. If the redundant time stamp 224 and the primary time stamp 124 do not match and/or do not correspond (e.g., because the primary time stamp 124 is stuck at a constant value), a fault is detected. The redundant time stamp 224 and the primary time stamp 124 may be compared using software running on the processor unit 162. Alternatively, the redundant time stamp 224 and the primary time stamp 124 may be compared using dedicated hardware.

It should be noted that the redundant time stamp 224 and the primary time stamp 124 may differ from one another. On the other hand, the redundant time stamp 224 and the primary time stamp 124 may have a pre-determined relationship with one another (e.g., a pre-determined ratio and/or a pre-determined offset). The pre-determined relationship between both time stamps 124, 224 may be taken into account (by the Software), when determining whether or not the redundant time stamp 224 and the primary time stamp 124 match and/or correspond. It may be determined that the redundant time stamp 224 and the primary time stamp 124 match and/or correspond, if the redundant time stamp 224 and the primary time stamp 124 exhibit the pre-determined relationship. On the other hand, it may be determined that the redundant time stamp 224 and the primary time stamp 124 do not match and/or do not correspond, if the redundant time stamp 224 and the primary time stamp 124 do not exhibit the pre-determined relationship.

When receiving a new frame 122, a flag “Rx has happened” may be set. Such a flag may be set by the DMA controller 115 in hardware or by software, e.g., running on the processor unit 162. Furthermore, the flag may be cleared by software (e.g., running on the processor unit 162). By way of example, the software running on the processor unit 162 may read the time stamps 124, 224 from the register module 221. The flag “Rx has happened” may be checked, in order to verify whether or not the time stamps 124, 224 should have been updated. If the flag “Rx has happened” is set, the redundant time stamp 224 and the primary time stamp 124 may be compared (as outlined above). On the other hand, if the flag “Rx has happened” is not set, the comparison of the redundant time stamp 224 and the primary time stamp 124 may be omitted.

For a new frame 122 with a time stamp 124 (possibly only for the frames used for clock and/or time synchronization), the CRC may be calculated over the data of the frame 122 and the associated time stamp 124, which are stored within the memory module 116 (e.g., using software running on the processor unit 162). This CRC may be referred to as verification data. The calculated CRC (i.e., the verification data) may be compared with the stored validation data 211 (stored within the RAM 116). When the verification data and the stored validation data 211 do not correspond, the frame 122 may be discarded and a hardware fault may be reported. Otherwise frame and time stamp processing may be continued.

It should be noted that the validation data 211 is typically determined using hardware (i.e., the generator 210). On the other hand, the verification data is typically determined using software (running on the processor unit 162).

The captured time stamp 124 and the redundant time stamp 224 may be provided to a register module 221 repeatedly (e.g., every 100 ms). The register module 221 may comprise a register for each time stamp 124, 224. The values (i.e., the time stamps) 124, 224 of the respective times 123, 223 (which are provided by the respective timers 163, 164) may be written into the respective registers of the register module 221. Hence, the register module 221 provides a consistent snapshot of the content of the time stamp capture modules 114, 220 (wherein the time stamp capture modules 114, 220 may each be implemented as registers).

A software (e.g., of the processor unit 162) may access the registers of register module 221 (repeatedly, e.g., every 100 ms) for comparing the captured time stamp 124 and the redundant time stamp 224. It may be checked whether both time stamps 124, 224 fit together and/or correspond, wherein an unexpected difference may indicate a hardware fault.

If the “Rx has happened” flag is set (or more generally, if a reception has occurred within the observation interval), it may be checked whether the time stamp 124 has stepped forward. This allows detection of a stuck timer fault and/or of a problem in SFD generation within the trigger module 111. After processing, the “Rx has happened” flag may be cleared.

FIG. 1C shows an example of a transmission unit 130 which comprises similar modules to the ones of the reception unit 110. It should be noted that the features which have been described in the context of the reception unit 110 are also valid (in a corresponding manner) for the transmission unit 130.

The processing device 160 may comprise a memory module 136 (e.g., a RAM) for storing data which may be passed to a DMA controller 135 via an interface bus 147. The memory module 136 may be part of the transmission unit 130 in the communication interface 161. In this case, the DMA controller 135 may be omitted. Individual frames 146 may be stored within a storage module 133 (e.g., a FIFO module). The metadata of an extended frame 146 (which comprises a data frame 142) may be analyzed using a time stamp control module 134, which is configured to decide (based on the metadata of the extended frame 146) whether or not a time stamp 124 is to be stored in conjunction with the frame 146 within the memory module 136 (wherein the frame 146 is already stored within the memory module 136).

The transmission unit 130 comprises a time stamp capture module 114 which is configured to capture a time stamp 124 at each SFD 121 of a data frame 142, based on a timer value 123 of a primary timer 163 (which may be synchronized using gPTP). The time stamp 124 may be stored in conjunction with the frame 146 within the memory module 136.

As already outlined in the context of the reception unit 110 and as shown in FIG. 2B, the transmission unit 130 may comprise a generator 210 which is configured to generate validation data 211. Furthermore, the reception unit 110 may comprise a redundant capture module 220 and a register module 221.

On all individual transmission (Tx) events (when the DMA controller 135 has fetched a new frame 146 from the RAM 136), the flag “Tx has happened” may be set (by hardware or by software, when providing a frame 146 for fetching). Such a flag may be set by the DMA controller 135 in hardware and may be cleared by software (e.g., the software of the processor unit 162).

For a transmission event with a time stamp (which may be the case only for the frames of clock and/or time synchronization) a CRC may be calculated over the Tx frame 142 and the Tx time stamp 124, wherein are stored within the memory module 136 (e.g., using software running on the processor unit 162). This CRC may be referred to as verification data. Furthermore, the calculated CRC (i.e., the verification data) may be compared with the stored validation data 211 (stored within the memory module 136). When they differ a signal transmission problem may be detected, and a hardware fault may be reported. Otherwise, TS processing may be continued.

The time stamp 124 and the redundant time stamp 224 may be provided to the register module 221. A software of the processor unit 162 may check whether both fit together. The register module 221 may comprise or may consist in a (“special function”) register for storing the values of the time stamps 124, 224. A software (of the processor unit 162) may access the registers of the register module 221, and may perform a software-based comparison of the time stamps 124, 224. An unexpected difference (which deviates from the pre-determined relationship between the time stamps 124, 224) indicates a hardware fault.

If the “Tx has happened” flag is set (or more generally, if a transmission event has occurred), it may be checked whether the time stamp 124 has stepped forward, thereby allowing detection of a stuck timer fault and/or a problem in SFD generation.

Subsequently, the “Tx has happened” flag may be cleared.

FIG. 1D shows an example of a data package 170 which may be received over the communication path 100 by a reception unit 110 (notably by module 111) and/or which may be transmitted over the communication path 100 by a transmission unit 130 (notably by module 131). The data package 170 comprises the data frame 122, 142. Furthermore, the data package 170 typically comprises additional data 171 (with one or more data field). In case of Ethernet, the data package 170, the additional data 171 may comprise a preamble, the SFD, FCS (frame check sequence) and/or the IFG (interframe gap). The validation data 211 may be determined based on the data frame 122, 142 only (excluding the additional data 171). The trigger 121 may be comprised within the additional data 171 (as is the case e.g., for Ethernet) or within the data frame 122, 142 (as may be the case for CAN).

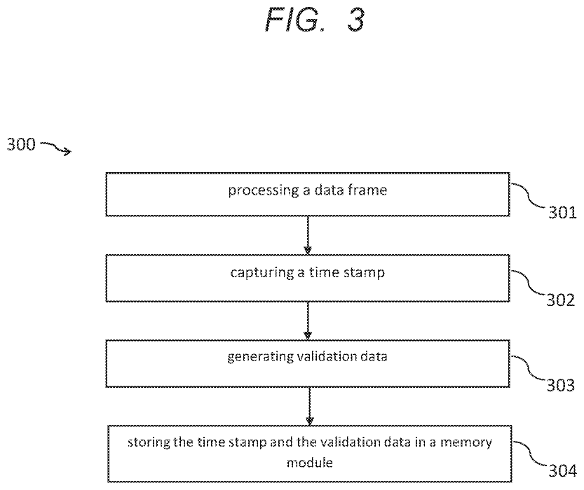

FIG. 3 shows a flow chart of an example (possibly computer-implemented) of a method 300 for time stamping data at a reception unit 110 and/or at a transmission unit 130 in a communication interface 161. The method 300 is directed at providing a reliable synchronization of time across different communication interfaces 161 within a communication network. The data may comprise sensor data that is provided by one or more sensors, e.g., vehicle sensors. The method steps may be performed by software and/or hardware.

The method 300 comprises processing 301 a data frame 122, 142 comprising data, wherein the processing 301 may comprise receiving the data frame 122 or sending the data frame 142.

Furthermore, the method 300 comprises, upon reception of a trigger 121 (for example, a start frame delimiter (SFD)) which is indicative of the processing 301 of the data frame 122, 142, capturing 302 a time stamp 124 using a primary timer 163 (wherein the primary timer 163 provides the primary time 123). The time stamp 124 may be captured using a (hardware-based) time stamp capture module 114, wherein the time stamp capture module 114 may be configured to capture the time 134 which is indicated by the primary timer 163 in reaction to receiving the trigger 121.

In addition, the method 300 comprises generating 303 validation data 211 based on the data frame 122, 142 and the time stamp 124. The validation data 211 may comprise an error-detecting code which is generated using a pre-determined data generation method.

The method 300 further comprises storing 304 the validation data 211 in conjunction with the data frame 122, 142 and the time stamp 124 in a memory module 116, 136 (e.g., in RAM), wherein the memory module 116, 136 may be accessible by an application software (which makes use of the reception unit 110 and/or of the transmission unit 130 for exchanging data frames 122, 142 with one or more other entities). By way of example, the application software may be configured to fuse sensor data which is provided by a plurality of different (vehicle) sensors. The application software may run on a processor unit 162 of a processing device 160 which may comprise the reception unit 110 and/or the transmission unit 130.

It should be noted that when receiving data, the validation data 211, the data frame 122 and the time stamp 124 may be stored jointly and/or actively in the memory module 116. On the other hand, when transmitting data, the data frame 142 is typically already stored within the memory module 136 (prior to generating the time stamp 124 and/or the validation data 211). In this case, the data frame 142 may be fetched from the memory module 136 for generating the validation data 211. Subsequently, the validation data 211 and/or the time stamp 124 may be stored in the memory module 136 (in conjunction with and/or linked to the already stored data frame 142).

The validation data 211 may be used for verifying whether or not the time stamp 124 (that is stored within the memory module 116, 136 in conjunction with the data frame 122, 142) has been altered and/or is incorrect. Hence, the method 300 may comprise validating the time stamp 124 based on the validation data 211. As a result of this, reliable time stamping of data is achieved (notably according to an ASIL D integrity level).

Hence, a processing device 160 is described, which is configured to provide reliable time stamping of data (at a pre-determined ASIL level). The processing device 160 may be a reception unit and/or may be configured to receive one or more data frames 122. Alternatively, or in addition, the processing device 160 may be a transmission unit and/or may be configured to send one or more data frames 142.

The processing device 160 is configured to process a data frame 122, 142 comprising data. Processing may comprise receiving the data frame 122 via a data communication path 100. Alternatively, or in addition, processing may comprise sending the data frame 142 via a data communication path 100. The data frame 122, 142 may be an Ethernet frame or a CAN frame. The data communication path 100 may be an Ethernet link or a CAN bus. The CAN communication may comply with CAN 2.0, CAN-FD and/or CAN-XL.

Furthermore, the processing device 160 may be configured, upon reception of a trigger 121 which is indicative of the processing of the data frame 122, 142, to capture a time stamp 124 using a primary timer 163. A time stamp 124 of the primary time 123 which is provided by the primary timer 163 may be captured. The primary time 123 may be provided by a primary timer 163 of the processing device 160. The primary timer 163 may have been synchronized with one or more other processing devices 160 within a communication network comprising the data communication path 100 using a synchronization method (such as gPTP (generalized Precision Time Protocol)). An offset and/or a rate of the primary timer 163 may have been determined using a synchronization method.

The trigger 121 may be a start frame delimiter (SFD) of an data package 170 in case of Ethernet. The time stamp 124 may be captured using a hardware-based time stamp capture module 114.

The processing device 160 may further be configured to generate validation data 211 based on the data frame 122, 142 and the time stamp 124 (using a (pre-determined) data generation method). The validation data 211 may be such that the validation data 211 enables a verification on whether the time stamp 124 which is stored in conjunction with the data frame 122, 142 has been altered with regards to the time stamp 124 that has been captured upon reception of the trigger 121. The validation data 211 may comprise an error-detecting code, notably a cyclic redundancy check (CRC), determined based on the data of the data frame 122, 142 and the time stamp 124.

The validation data 211 may be stored in conjunction with the data frame 122, 142 and the time stamp 124 in a memory module 116, 136. By way of example, the validation data 211, the data frame 122, 142 and the time stamp 124 may be stored in the memory module 116, 136 using a DMA controller 115, 135. Alternatively, the validation data 211, the data frame 122, 142 and the time stamp 124 may be stored in a local memory module 116, 136 (without using a DMA controller 115, 135), as is the case e.g., within a CAN network. The memory module 116, 136 may be a random access memory (RAM), e.g., a local RAM. An application software (e.g., running on a processor unit 162 of the processing device 160) may access the memory module 116, 136 to make use of the data frame 122, 142 and the time stamp 124. Furthermore, the application software may make use of the validation data 211 for verifying the correctness of the time stamp 124. As a result of this, a reliable scheme for time stamping data is provided.

The memory module 116, 136 may be part of a communication interface 161 of the processing device 160, wherein the communication interface 161 comprises a transmission unit 130 and/or a reception unit 110. The reception unit 110 and/or the transmission unit 130 may each comprise a memory module 116, 136. In this case, the DMA controller 115, 135 may be omitted. Alternatively, or in addition, the processing device 160 may comprise one or more memory modules 116, 136 which are located outside of the communication interface 161 (e.g., as part of the processor unit 162). In this case, the transmission unit 130 and/or the reception unit 110 in the communication interface 161 may comprise a DMA controller 115, 135.

By using software on the processor unit 162, the processing device 160 may be configured to verify, based on the validation data 211, whether or not the time stamp 124 that is stored in conjunction with the data frame 122, 142 within the memory module 116, 136 has been altered and/or is incorrect. For this purpose, by using software on the processor unit 162, the processing device 160 may generate verification data based on the data frame 122, 142 and the time stamp 124, which are stored within the memory module 116, 136. The verification data may be generated using the same data generation method (notably the same method for generating an error-detecting code) as the one which has been used for generating the validation data 211.

The verification data may be compared with the validation data 211 that is stored in conjunction with the data frame 122, 142 within the memory module 116, 136. It may then be determined, based on the comparison of the verification data with the validation data 211, whether or not the time stamp 124 that is stored in conjunction with the data frame 122, 142 within the memory module 116, 136 has been altered and/or is incorrect. It may be concluded that the time stamp 124 has not been altered and/or is correct, if the verification data and the validation data 211 are identical and/or match. Otherwise, it may be concluded that the time stamp 124 has been altered and/or is incorrect.

The processing device 160 may be configured to report a fault, if it is determined that the time stamp 124 that is stored in conjunction with the data frame 122, 142 within the memory module 116, 136 has been altered and/or is incorrect. Alternatively, or in addition, the processing device 160 may be configured to discard the data frame 111, 131 from the memory module 116, 136, if it is determined that the time stamp 124 that is stored in conjunction with the data frame 122, 142 within the memory module 116, 136 has been altered and/or is incorrect.

As a result of this, the reliably of an application software which makes use of time stamped data frames 122, 142 may be increased.

The processing device 160 may be configured to determine whether or not the data frame 122, 142 comprises data used for clock and/or time synchronization (e.g., for synchronizing the clock which is used for providing the primary time 123). The verification whether or not the time stamp 124 that is stored in conjunction with the data frame 122, 142 within the memory module 116, 136 has been altered and/or is incorrect, may be performed if, it is determined that the data frame 122, 142 is a frame used for clock and/or time synchronization.

In other words, the verification of the time stamping may be performed only for a fraction of the data frames 122, 142 that are processed by the processing device 160, thereby providing an improved compromise between reliability and computing efficiency. It may be ensured that all data frames 122, 142 which relate to clock and/or time synchronization (notably gPTP frames) are verified, thereby providing a high integrity (notably ASIL) level regarding clock and/or time synchronization in an efficient manner.

The processing device 160 may be configured to capture a redundant time stamp 224 using a secondary timer 164 (e.g., a software-based or hardware-based timer), upon reception of the trigger 121 which is indicative of the processing of the data frame 122, 142. The secondary timer 164 may be configured to provide a secondary time 223. The time stamp 124 may be compared with the redundant time stamp 224. Furthermore, it may be verified, based on the comparison, whether or not the time stamp capture module 114 for capturing the time stamp 124 and/or the trigger module 111, 131 for generating the trigger 121 are faulty. As a result of this, the reliability of time stamping may be further improved.

By running software on the process unit 162, the processing device 160 may be configured to determine a time interval and/or a number of data frames 122, 142 since it has last been verified whether or not the time stamp capture module 114 for capturing the time stamp 124 and/or the trigger module 111, 131 for generating the trigger 121 are faulty. The redundant time stamp 224 may be captured (for verifying the time stamp capture module 114 and/or the trigger module 131) and/or the time stamp 124 may be compared with the redundant time stamp 224, if the time interval is equal to or greater than a pre-determined verification time (e.g., 100 ms) and/or the number of data frames 122, 142 is equal to or greater than a pre-determined verification number (e.g., 10). By doing this, an improved compromise between reliability and computing efficiency may be provided.

The processing device 160 may be configured to set a flag which is indicative of a new data frame 122, 142 upon processing of the data frame 122, 142. Furthermore, the processing device 160 may be configured to clear the flag subsequent to verifying whether or not the time stamp capture module 114 for capturing the time stamp 124 and/or the trigger module 111, 131 for generating the trigger are faulty. By doing this, the reliability of the described verification scheme may be further improved (by avoiding false positives).

The components of the processing device 160, which are depicted in FIG. 2A (for the reception unit 110) and/or in FIG. 2B (for the transmission unit 130) may be implemented as hardware only (wherein the memory module 116, 136 may be implemented separately, e.g., as memory within the processor unit 162). Hence, the tasks which are performed by the depicted components, the one or more time stamp capture modules 114, 220, the register module 221 and/or the generator 210 may be performed by hardware only. The validation data 211 may be generated using a hardware-based (CRC) generator 210.

On the other hand, other tasks, such as the calculation of the verification data, the comparison of the validation data 211 and the verification data and/or the comparison of the time stamps 124, 224 may be performed using software running of the processor unit 162 of the processing device 160.

It should be noted that the processing device 160 may comprise one or more communication interfaces 161 which are configured as described in the present document (for generating validation data 211 for the verification of a time stamp 124). Furthermore, the processing device 160 may comprise one or more communication interfaces which do not comprise the time stamp verification schemes which are described in the present document (and which are designed as described in the context of FIGS. 1b and 1c). Furthermore, it should be noted that the processing device 160 and/or a communication interface 161 of the processing device 160 may be configured to provide validation data 211 for verification of a time stamp 124 only for a sub-set of data frames 122, 142.

It should be noted that the description and drawings merely illustrate the principles of the proposed methods and systems. Those skilled in the art will be able to implement various arrangements that, although not explicitly described or shown herein, embody the principles of the invention and are included within s spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A processing device is configured to:
process a data frame upon reception of a trigger which is indicative of processing of the data frame;
capture a time stamp using a primary timer;
generate validation data based on the data frame and the time stamp; and
store the validation data in conjunction with the data frame and the time stamp in a memory module.

2. The processing device according to claim 1,
wherein the validation data enables a verification on whether the time stamp which is stored in conjunction with the data frame altered with regards to the time stamp captured upon reception of the trigger.

3. The processing device according to claim 1,
wherein the validation data comprises an error-detecting code determined based on the data of the data frame and the time stamp.

4. The processing device according to claim 1,
wherein the processing device is configured to:
verify, based on the validation data, whether or not the time stamp that is stored in conjunction with the data frame within the memory module has been altered and/or is incorrect; and
report a fault, if it is determined that the time stamp that is stored in conjunction with the data frame within the memory module has been altered and/or is incorrect.

5. The processing device according to claim 4,
wherein the processing device is configured to discard the data frame from the memory module, if it is determined that the time stamp that is stored in conjunction with the data frame within the memory module has been altered and/or is incorrect.

6. The processing device according to claim 4,
wherein the processing device is configured to:
generate verification data based on the data frame and the time stamp, which are stored within the memory module;
compare the verification data with the validation data that is stored in conjunction with the data frame within the memory module; and
determine, based on the comparison of the verification data with the validation data, whether or not the time stamp that is stored in conjunction with the data frame within the memory module has been altered and/or is incorrect,
wherein the verification data is generated using a data generation method which is identical to the one used for generating the validation data.

7. The processing device according to claim 4,
wherein the processing device is configured to:
determine whether or not the data frame comprises data used for clock and/or time synchronization; and
verify whether or not the time stamp that is stored in conjunction with the data frame within the memory module has been altered and/or is incorrect, if it is determined that the data frame is a frame used for clock and/or time synchronization.

8. The processing device according to claim 1,
wherein the processing device is configured to:
capture a redundant time stamp using a secondary timer upon reception of the trigger which is indicative of the processing of the data frame;
compare the time stamp with the redundant time stamp; and
verify, based on the comparison of the time stamp with the redundant time stamp, whether or not a time stamp capture module for capturing the time stamp and/or a trigger module for generating the trigger are faulty.

9. The processing device according to claim 8,
wherein the processing device is configured to:
determine a time interval and/or a number of data frames since it has last been verified whether or not the time stamp capture module for capturing the time stamp and/or the trigger module for generating the trigger are faulty; and
compare the time stamp with the redundant time stamp, if the time interval is equal to or greater than a pre-determined verification time and/or the number of data frames is equal to or greater than a pre-determined verification number.

10. The processing device according to claim 1,
wherein the processing device is configured to receive the data frame; and
processing comprises receiving the data frame via a data communication path.

11. The processing device according to claim 1,
wherein the processing device is configured to send the data frame; and
processing comprises sending the data frame via a data communication path.

12. The processing device according to claim 1,
wherein the data frame is an Ethernet frame or a CAN frame or a PCIe frame.

13. The processing device according to claim 1,
wherein the time stamp is captured using a hardware-based time stamp capture module and/or the validation data and the time stamp are stored in the memory module using a direct memory access controller.

14. A method for time stamping data at a communication interface:
processing a data frame comprising data upon reception of a trigger which is indicative of the processing of the data frame;
capturing a time stamp using a primary timer;
generating validation data based on the data frame and the time stamp; and
storing the validation data in conjunction with the data frame and the time stamp in a memory module.
